(19) United States
(12) Patent Application Publication
(10) Pub. No.: US 2024/0122086 A1
(43) Pub. Date: Apr. 18, 2024

(54) Disc Plow Weight Mounting Bracket Device

(71) Applicant: Peter Elsbach, Myersville, MD (US)

(72) Inventor: Peter Elsbach, Myersville, MD (US)

(21) Appl. No.: 18/470,530

(22) Filed: Sep. 20, 2023

Related U.S. Application Data
(60) Provisional application No. 63/415,343, filed on Oct. 12, 2022.

(51) Int. Cl. A01B 15/14; A01B 5/00

(52) U.S. Cl. CPC A01B 15/14; A01B 5/00

(57) ABSTRACT

A disc plow weight mounting bracket device is provided. The device is designed to be used to allow a user to easily and securely attach weight to a disc plow frame, specifically above a disc gang. A base plate and a secondary base plate can be used to attach the device to the frame of a disc plow. Then, the weight can be slid onto the vertical member and secured on the vertical member via the fastener to provide additional weight to the plow, specifically above the disc gang.

### CROSS-REFERENCE TO RELATED APPLICATION

The present application claims priority to, and the benefit of, U.S. Provisional Application No. 63/415,343, which was filed on Oct. 12, 2022, and is incorporated herein by reference in its entirety.

### FIELD OF THE INVENTION

The present invention relates generally to the field of plows. More specifically, the present invention relates to a disc plow weight mounting bracket device that can be attached to a disc plow to allow a user to load more weight onto the plow above at least one disc gang to improve the workability of the plow. Accordingly, the present disclosure makes specific reference thereto. Nonetheless, it is to be appreciated that aspects of the present invention are also equally applicable to other like applications, devices, and methods of manufacture.

### BACKGROUND

When using vehicles such as a tractor or ATV in order to dig into a thatch or brush area, one may encounter a significant challenge due to the inherent lack of weight of said vehicles. This insufficiency of weight on said particular types of vehicles makes it difficult for any attachment of the vehicle (ex. a plow) to effectively penetrate a ground surface. Consequently, individuals must add weight to said vehicles or any plowing devices attached to said vehicles.

Placing added weights above the disc gangs of a disc plow serves as a viable solution to this predicament, as the weights effectively exert downward force, thereby pushing the disc gangs further into the ground. This enhanced ground penetration results in superior tilling outcomes, all achieved with the aid of a relatively small vehicle and a disc plow. However, there is no efficient and safe manner to easily and securely apply weights to a disc plow in said manner.

Therefore, there exists a long-felt need in the art for a device that allows a user to apply weights to a plow being used with a tractor, ATV, or other vehicle of the like. More specifically, there exists a long-felt need in the art for a disc plow weight mounting bracket device that allows a user to apply weight to a disc plow. Furthermore, there exists a long-felt need in the art for a disc plow weight mounting bracket device that allows a user to apply weight to a disc plow, specifically at a position above a disc gang of a disc plow.

The subject matter disclosed and claimed herein, in one embodiment thereof, comprises a disc plow weight mounting bracket device. The device is designed to be used to allow a user to easily and securely attach weight to a disc plow frame, specifically above a disc gang. The device is primarily comprised of a base plate with at least one vertical member, a secondary base plate, at least one fastener, and at least one weight. The base plate and secondary base plate can be used to attach the device to the frame of a disc plow. Then, the weight can be slid onto the vertical member and secured on the vertical member via the fastener to provide additional weight to the plow, specifically above the disc gang.

In this manner, the disc plow weight mounting bracket device of the present invention accomplishes all the foregoing objectives and provides a device that allows a user to apply weights to the plow being used with a tractor, ATV, or another vehicle of the like. More specifically, the device allows a user to apply weight to a disc plow. Furthermore, the device allows a user to apply weight to a disc plow, specifically at a position above a disc gang of a disc plow.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a disc plow weight mounting bracket device designed to be used to allow a user to easily and securely attach weight to a disc plow frame, and more specifically on the area of the frame atop or near at least one disc gang. The device is primarily comprised of a base plate with at least one vertical member, at least one secondary base plate, at least one fastener, and at least one weight.

The base plate is preferably rectangular or square and is comprised of at least one opening that receives at least one fastener. To attach the device to the frame of a disc plow, at least one secondary base plate is positioned underneath a frame member of the plow. The base plate is comprised of at least one opening that receives at least one fastener.

More specifically, at least one fastener (which is preferably, but not limited to, a threaded bolt) is passed through both openings of each base plate. Then, at least one secondary fastener (such as, but not limited to, a nut, a nut and washer assembly, etc.) can be placed on one end of the fastener and tightened to secure both base plates on opposing top and bottom sides of the frame via compressive force. In an alternative embodiment, the base plate is comprised of at least one clip, pin, or clamp fastener that allows the base plate to removably attach to the frame.

Once secure to the frame, at least one weight may be placed on at least one vertical member that extends upwards away from the top surface of the base plate. Once slid onto the vertical member, the weight can be secured in place (i.e., to inhibit upward movement during the use of the plow) via at least one fastener.

The present invention is also comprised of a method of using the device. First, a device is provided comprised of a base plate with at least one vertical member, at least one weight with at least one opening, and at least one fastener. Then, the base plate and at least one secondary base plate can be secured on opposite sides of a disc plow frame by using at least one first fastener and at least one secondary fastener to secure the base plate to the secondary base plate. The base plates are preferably positioned over the top (or near) a disc gang of a disc plow during the attachment process to provide adequate weight downwards onto the disc gang during use for better plowing. Then, at least one weight can be placed onto the vertical member via an opening of the weight and secured on the vertical member via at least one fastener. Finally, the disc plow can be attached to a tractor, ATV, or other vehicle of the like and used to plow/till soil.

Similarly, a second method of using the device involves providing a device comprised of a base plate with at least one vertical member, at least one weight with at least one opening, and at least one fastener. Then, at least one fastener of the base plate can be used to secure the base plate to the frame of a disc plow. The base plate is positioned over top (or near) a disc gang of a disc plow during the attachment process to provide adequate weight downwards onto the disc gang during use for better plowing. Then, at least one weight can be placed onto the vertical member via an opening of the weight and secured on the vertical member via at least one fastener. Finally, the disc plow can be attached to a tractor, ATV, or other vehicle of the like and used to plow/till soil.

Accordingly, the disc plow weight mounting bracket device of the present invention is particularly advantageous as it provides a device that allows a user to apply weights to the plow being used with a tractor, ATV, or another vehicle of the like. More specifically, the device that allows a user to apply weight to a disc plow. Furthermore, the device allows a user to apply weight to a disc plow, specifically at a position above a disc gang of a disc plow. In this manner, the disc plow weight mounting bracket device provides a solution to adding weight to disc plows safely, securely and efficiently.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a disc plow weight mounting bracket device of the present invention in accordance with the disclosed architecture;

FIG. 2 illustrates a side view of one potential embodiment of a disc plow weight mounting bracket device of the present invention in accordance with the disclosed architecture;

FIG. 3 illustrates a perspective view of one potential embodiment of a disc plow weight mounting bracket device of the present invention while attached to the disc plow in accordance with the disclosed architecture;

FIG. 4 illustrates a flowchart of a method of using one potential embodiment of a disc plow weight mounting bracket device of the present invention in accordance with the disclosed architecture; and

FIG. 5 illustrates a flowchart of a method of using one potential embodiment of a disc plow weight mounting bracket device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not show all the aspects or advantages. Thus, in other embodiments, any of the features described herein from different embodiments may be combined.

As noted above, there exists a long-felt need in the art for a device that allows a user to apply weights to a plow being used with a tractor, ATV, or other vehicle of the like. More specifically, there exists a long-felt need in the art for a disc plow weight mounting bracket device that allows a user to apply weight to a disc plow. Furthermore, there exists a long-felt need in the art for a disc plow weight mounting bracket device that allows a user to apply weight to a disc plow, specifically at a position above a disc gang of a disc plow.

The present invention, in one exemplary embodiment, is comprised of a disc plow weight mounting bracket device designed to be used to allow a user to easily and securely attach weight to a disc plow frame, and more specifically on the area of the frame atop or near at least one disc gang. The device is primarily comprised of a base plate with at least one vertical member, at least one secondary base plate, at least one fastener, and at least one weight.

The base plate is preferably rectangular or square and is comprised of at least one opening that receives at least one fastener. To attach the device to the frame of a disc plow, at least one secondary base plate is positioned underneath a frame member of the plow. The base plate is comprised of at least one opening that receives at least one fastener. More specifically, at least one fastener (which is preferably, but not limited to, a threaded bolt) is passed through both openings of each base plate. Then, at least one secondary fastener (such as, but not limited to, a nut, a nut and washer assembly, etc.) can be placed on one end of the fastener and tightened to secure both base plates on opposing top and bottom sides of the frame via compressive force. In an alternative embodiment, the base plate is comprised of at least one clip, pin, or clamp fastener that allows the base plate to removably attach to the frame.

Once secure to the frame, at least one weight may be placed on at least one vertical member that extends upwards away from the top surface of the base plate. Once slid onto the vertical member, the weight can be secured in place (i.e., to inhibit upward movement during the use of the plow) via at least one fastener.

The present invention is also comprised of a method of using the device. First, a device is provided comprised of a base plate with at least one vertical member, at least one weight with at least one opening, and at least one fastener. Then, the base plate and at least one secondary base plate can be secured on opposite sides of a disc plow frame by using at least one first fastener and at least one secondary fastener to secure the base plate to the secondary base plate. The base plates are preferably positioned over top (or near) a disc gang of a disc plow during the attachment process to provide adequate weight downwards onto the disc gang during use for better plowing. Then, at least one weight can be placed onto the vertical member via an opening of the weight and secured on the vertical member via at least one fastener. Finally, the disc plow can be attached to a tractor, ATV, or other vehicle of the like and used to plow/till soil.

Similarly, a second method of using the device involves providing a device comprised of a base plate with at least one vertical member, at least one weight with at least one opening, and at least one fastener. Then, at least one fastener of the base plate can be used to secure the base plate to the frame of a disc plow. The base plate is positioned over top (or near) a disc gang of a disc plow during the attachment process to provide adequate weight downwards onto the disc gang during use for better plowing. Then, at least one weight can be placed onto the vertical member via an opening of the weight and secured on the vertical member via at least one fastener. Finally, the disc plow can be attached to a tractor, ATV, or other vehicle of the like and used to plow/till soil.

Accordingly, the disc plow weight mounting bracket device of the present invention is particularly advantageous as it provides a device that allows a user to apply weights to the plow being used with a tractor, ATV, or another vehicle of the like. More specifically, the device that allows a user to apply weight to a disc plow. Furthermore, the device allows a user to apply weight to a disc plow, specifically at a position above a disc gang of a disc plow. In this manner, the disc plow weight mounting bracket device provides a solution to adding weight to disc plows safely, securely, and efficiently.

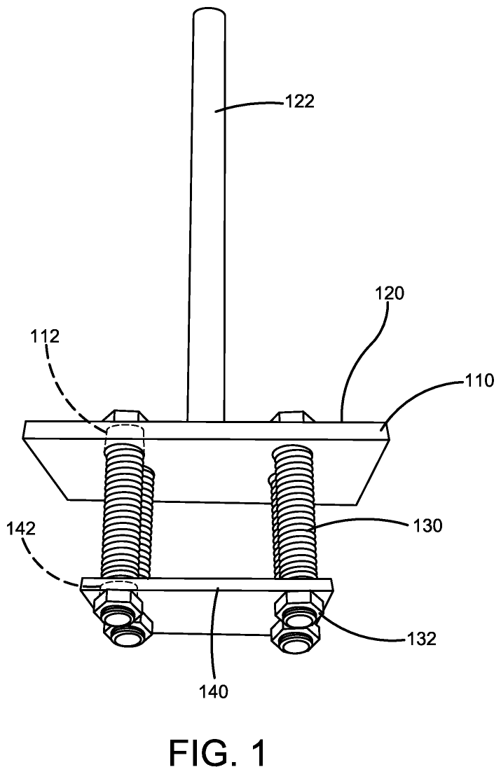

Referring initially to the drawings, FIG. 1 illustrates a perspective view of one potential embodiment of a disc plow weight mounting bracket device 100 of the present invention in accordance with the disclosed architecture. The device 100 is designed to be used to allow a user to easily and securely attach weight to a disc plow 10 frame 14, and more specifically on the area of the frame 14 atop or near at least one disc gang 12. The device 100 is primarily comprised of a base plate 110 with at least one vertical member 122, at least one secondary base plate 140, at least one fastener 130, and at least one weight 124. All components of the device 100 are preferably made from a durable and corrosion-resistant metal material for structural integrity.

The base plate 110 is preferably rectangular or square in shape but may be any shape in different embodiments. The base plate 110 is comprised of at least one opening 112 that receives at least one fastener 130. The opening 112 may be threaded or non-threaded in different embodiments.

To attach the device 100 to the frame 14 of a disc plow 10, at least one secondary base plate 140 is positioned underneath a frame 14 member of the plow 10. The base plate 140 is preferably rectangular or square in shape but may be any shape in different embodiments. The base plate 140 is comprised of at least one opening 142 that receives at least one fastener 130. The opening 142 may be threaded or non-threaded in different embodiments.

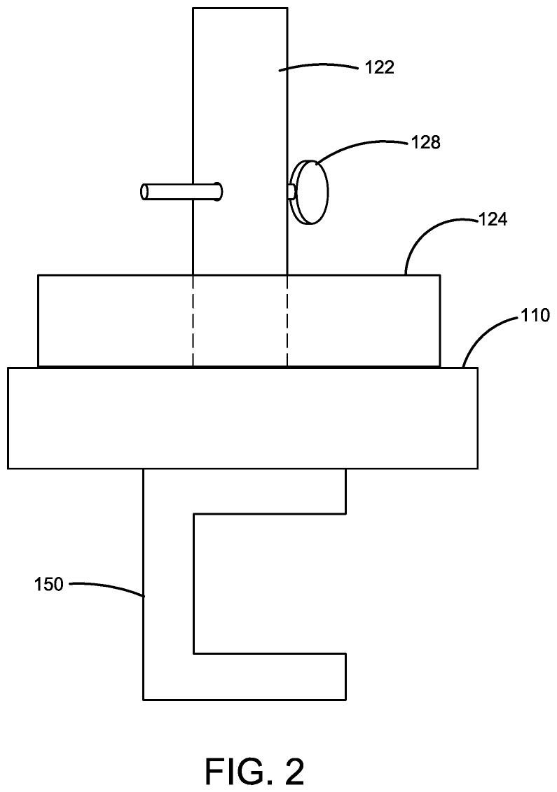

More specifically, at least one fastener 130 (which is preferably, but not limited to, a threaded bolt) is passed through both openings 142,112 of each base plate 110,140. Then, at least one secondary fastener 132 (such as, but not limited to, a nut, a nut and washer assembly, etc.) can be placed on one end of the fastener 130 and tightened to secure both base plates 110,140 on opposing top and bottom sides of the frame 14 via compressive force. In an alternative embodiment, the base plate 110 is comprised of at least one clip, pin, or clamp fastener 150 that allows the base plate 110 to removably attach to the frame 14, as seen in FIG. 2. Said fastener 150 may include but is not limited to a C-clamp, a locking clamp, a pipe clamp, a screw clamp, a pipe clamp, a cotter pin, etc.

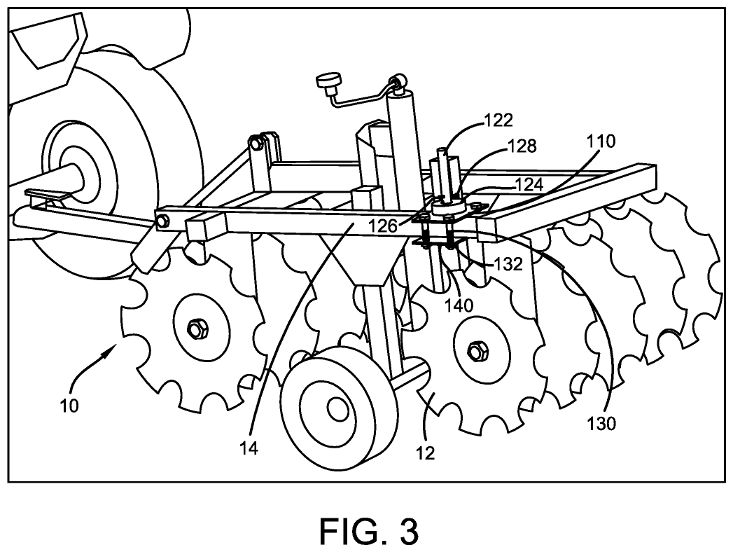

Once secure to the frame 14, at least one weight 124 may be placed on at least one vertical member 122 that extends upwards away from the top surface 120 of the base plate 110, as seen in FIG. 3. The weight 124 is preferably comprised of at least one opening 126 that allows the weight 124 to slide onto the vertical member 122. Once slid onto the vertical member 122, the weight 124 can be secured in place (i.e., to inhibit upward movement during use of the plow 10) via at least one fastener 128 such as, but not limited to, any type of clip, clamp, or pin known in the art that may engage all or a portion of the vertical member 122. The weight 124 may be any size, shape, weight, and material known in the art to allow a user to customize the amount of weight used with the device 100.

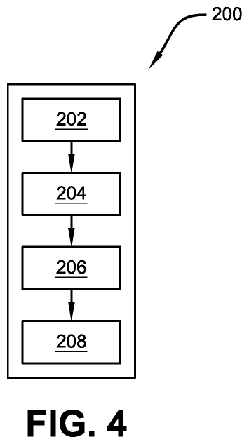

The present invention is also comprised of a method of using 200 the device 100, as seen in FIG. 4. First, a device 100 is provided comprised of a base plate 110 with at least one vertical member 122, at least one weight 124 with at least one opening 126, and at least one fastener 128 [Step 202]. Then, the base plate 110 and at least one secondary base plate 140 can be secured on opposite sides of a disc plow frame 14 by using at least one first fastener 130 and at least one secondary fastener 132 to secure the base plate 110 to the secondary base plate 140 [Step 204]. The base plates 110,140 are preferably positioned over top (or near) a disc gang 12 of a disc plow 10 during the attachment process to provide adequate weight downwards onto the disc gang 12 during use for better plowing. Then, at least one weight 124 can be placed onto the vertical member 122 via an opening 126 of the weight 124 and secured on the vertical member 112 via at least one fastener 128 [Step 206]. The device 100 is designed to be used to allow a user to easily and securely attach weight to a disc plow 10 frame 14, and more specifically on the area of the frame 14 atop or near at least one disc gang 12. The device 100 is primarily comprised of a base plate 110 with at least one vertical member 122, at least one secondary base plate 140, at least one fastener 130, and at least one weight 124. All components of the device 100 are preferably made from a durable and corrosion-resistant metal material for structural integrity. Finally, the disc plow 10 can be attached to a tractor, ATV, or other vehicle of the like and used to plow/till soil [Step 208].

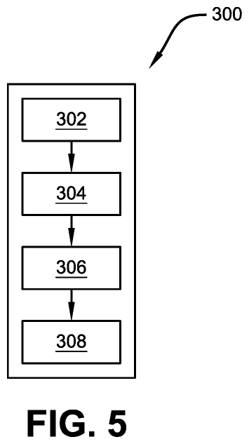

The present invention is also comprised of another method of using 300 the device 100, as seen in FIG. 5. First, a device 100 is provided comprised of a base plate 110 with at least one vertical member 122, at least one weight 124 with at least one opening 126, and at least one fastener 128 [Step 302]. Then, at least one fastener 150 of the base plate 110 can be used to secure the base plate 110 to the frame 14 of a disc plow 10 [Step 304]. The base plate 110 is positioned over top (or near) a disc gang 12 of a disc plow 10 during the attachment process to provide adequate weight downwards onto the disc gang 12 during use for better plowing. Then, at least one weight 124 can be placed onto the vertical member 122 via an opening 126 of the weight 124 and secured on the vertical member 112 via at least one fastener 128 [Step 306] Finally, the disc plow 10 can be attached to a tractor, ATV, or other vehicle of the like and used to plow/till soil [Step 308].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “disc plow weight mounting bracket device” and “device” are interchangeable and refer to the disc plow weight mounting bracket device 100 of the present invention.

Notwithstanding the foregoing, the disc plow weight mounting bracket device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the disc plow weight mounting bracket device 100 as shown in the FIGS. are for illustrative purposes only, and that many other sizes and shapes of the disc plow weight mounting bracket device 100 are well within the scope of the present disclosure. Although the dimensions of the disc plow weight mounting bracket device 100 are important design parameters for user convenience, the disc plow weight mounting bracket device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A disc plow weight mounting bracket device comprising:
a base plate comprised of a vertical member and a first opening;
a secondary base plate comprised of a second opening;
a first fastener;
a weight comprised of an opening; and
a second fastener.

2. A disc plow weight mounting bracket device of claim 1, wherein the first fastener is comprised of a threaded bolt.

3. A disc plow weight mounting bracket device of claim 1, wherein the first opening is comprised of a threaded opening.

4. A disc plow weight mounting bracket device of claim 1, wherein the second opening is comprised of a threaded opening.

5. A disc plow weight mounting bracket device of claim 1 further comprised of a nut or a nut and washer assembly.

6. A disc plow weight mounting bracket device of claim 1, wherein the vertical member is positioned on a top surface of the base plate.

7. A disc plow weight mounting bracket device of claim 1, wherein the first fastener is comprised of a clamp, a clip, or a pin.

8. A disc plow weight mounting bracket device comprising:
a base plate comprised of a vertical member, a first opening, and a first fastener;
a secondary base plate comprised of a second opening;
a second fastener received by the vertical member; and
a weight comprised of an opening.

9. A disc plow weight mounting bracket device of claim 8, wherein the first fastener is comprised of a clip or a clamp.

10. A disc plow weight mounting bracket device of claim 8, wherein the second fastener is comprised of a clip, a clamp, or a pin.

11. A disc plow weight mounting bracket device of claim 8, wherein the first opening is comprised of a threaded opening.

12. A disc plow weight mounting bracket device of claim 8, wherein the second opening is comprised of a threaded opening.

13. A disc plow weight mounting bracket device of claim 8, wherein the vertical member is positioned on a top surface of the base plate.

14. A method of using a disc plow weight mounting bracket device, the method comprising the following steps:
providing a disc plow weight mounting bracket device comprised of a base plate comprised of a vertical member, a weight comprised of an opening, and a first fastener;
securing the base plate to a frame of a disc plow;
placing the weight on the vertical member via the opening; and
securing the weight on the vertical member via the first fastener.

15. A method of using a disc plow weight mounting bracket device of claim 14, wherein the first fastener is comprised of a clip, a clamp, or a pin.

16. A method of using a disc plow weight mounting bracket device of claim 14 further comprised of a second mounting bracket.

17. A method of using a disc plow weight mounting bracket device of claim 16 further comprised of attaching the second mounting bracket to the first mounting bracket via a second fastener.

18. A method of using a disc plow weight mounting bracket device of claim 17 further comprised of positioning the first mounting bracket and the second bracket on the frame of the disc plow above a disc gang of the disc plow.

19. A method of using a disc plow weight mounting bracket device of claim 14, wherein the base plate is comprised of a clip, a clamp, or a pin.

20. A method of using a disc plow weight mounting bracket device of claim 19 further comprised of attaching the clip, the clamp, or the pin to the frame of the disc plow above a disc gang of the disc plow.
